(19) United States
(12) Patent Application Publication
(10) Pub. No.: US 2008/0279604 A1
(43) Pub. Date: Nov. 13, 2008

(54) ALL-IN-ONE COPIER DEVICE WITH BUILT-IN TYPEWRITER FUNCTION

(76) Inventor: Puthalath Koroth Raghuprasad, Odessa, TX (US)

Correspondence Address: DAVID L. KING, SR., 5131 N.E. COUNTY ROAD 340, HIGH SPRINGS, FL, 32643, US

(21) Appl. No.: 11/745,544

(22) Filed: May 8, 2007

(51) Int. Cl. B41J 5/10

(52) U.S. Cl. 400/472

(57) ABSTRACT

The present invention discloses a relatively inexpensive device 10 that can internally include on or more of the functions of a printer 30, fax machine 40, copier 50 or scanner 60 in combination with a built-in typewriter device 20. Preferably the device is an all-in-one type device 10 (20, 30, 40, 50, 60). That includes the features normally connected to a computer, but with an independently built-in operable typewriter function.

### TECHNICAL FIELD

The present invention relates to a device with a photocopying function and a built-in typewriter function.

### BACKGROUND OF THE INVENTION

With the advent of the personal computer work station, the use of a conventional typewriter has all but disappeared.

The computer in combination with a printer can print labels and envelopes and perform almost any word processing task required in a modern office.

Accordingly the use of a separate typewriter has virtually been eliminated.

Secondarily most offices have administrative secretarial work stations coupled electronically to a central printer/facsimile device resulting in a highly efficient word processing capability without the need of individual peripheral devices such as printers, copiers, scanners and fax machines.

This has created a desktop that typically has only a computer monitor and a keyboard and for most offices that is an ideal use of office space.

In many offices, however, the use of pre-printed forms is commonplace. In some cases for security reasons it is mandatory to use original forms. State and Federal Government offices, like the Internal Revenue Service for example require certain forms such as a 1099 Misc. to be filled out and submitted using their forms.

In many doctor's offices patient information is typed onto cards or forms, in some cases multi-page forms making the use of a conventional typewriter the only way such forms can be filled out.

Scanning software can be used and the form can be filled out electronically to a computer work station wherein a blank form can be fed into a printer, but it is most common that the data is not properly positioned onto the spaces due to the complexity of exactly matching the alignment of the form with the printer software scanned image. In U.S. Pat. No. 5,172,988 entitled “Form Printer with Interactive Camera and Computer Control”, the invention provides the user with the capability of viewing a form positioned in a printer associated with a computer, a keyboard and a monitor. The printer has a camera and a lens positioned thereon, the camera including an image sensing array for providing video signals corresponding to images sensed on the form. The computer processes the video signals to display images sensed on various portions of the form. The user responds by entering via a keyboard data corresponding to the various portions of the form displayed. During the first use of a form, the computer memorizes the portions of the form for which data are entered and on which data are to be printed. For subsequent uses of the form the corresponding data are entered via the keyboard, and the printer automatically fills in the subsequent form. However, alignment issues on subsequent forms still exist.

This device while facilitating form processing simply cannot effectively control the location or adjust adequately for misalignment of the subsequent forms, the use of a built-in camera is required to see if the form is properly aligned which involves re-setting the alignment if not accurate. These deficiencies are rooted in the fact the computer monitor and the operator are remotely located relative to the form printer. While it has the beneficial aspect of eliminating a separate typewriter, it needs a separate specialized form printer that unfortunately is not as accurate as a secretary at an old-fashioned conventional typewriter.

U.S. Pat. No. 4,775,953 entitled “A Workstation With Typewriter Emulation” was assigned to American Telephone and Telegraph Company. In this patent filed in 1986 it was then common to have both a typewriter and a computer at a workstation and the desire was to provide a computer that worked like a typewriter in that the software would direct the printer to respond to the keyboard on a keystroke-by-keystroke basis. In that patent it was noted that, Personal computers and workstations are becoming more and more commonplace in businesses of all sizes. Advantageously, these machines enable secretaries and other office workers to perform electronically and/or more automatically many functions that used to be performed by more manual means. Disadvantageously, however, the secretarial work area still typically must include a separate conventional typewriter to fill out pre-printed forms, type envelopes, etc. It is to the elimination of the need for that separate conventional typewriter that this prior art invention was directed. In accordance with that invention, a personal computer or workstation was provided with an arrangement whereby the workstation keyboard and a suitably designed printer was made to emulate the operation of, and have the look and feel of, a standard typewriter. In accordance with a first feature of the invention, the printer was designed to receive the workstation keyboard and to hold it such that the keyboard face is held at an angle to the horizontal. In preferred embodiments, the printer had a shelf whose perimeters defined an area at least as large as the keyboard and the shelf was designed to receive a mobile keyboard. With the workstation keyboard so placed, the printer/keyboard combination advantageously very much had the look and feel of a conventional typewriter—this was considered a critically important human factor consideration. In accordance with another feature of this invention, the keyboard had a top rear edge that was substantially adjacent to an upper surface of the printer when the keyboard is placed on the printer. This spatial relationship is another mechanism which, in accordance with the principles of the invention, promoted the illusion that the keyboard/printer combination was a typewriter. In accordance with a further feature of that invention, software within the workstation, when called into operation, causes the printer to respond to the keyboard on a keystroke-by-keystroke basis. Thus, as the user depressed a “data” key, i.e., a key associated with a character to be printed, the associated character was immediately printed by the printer and, similarly, as the user depressed a “command” key, such as the “return” key or “backspace” key, the associated function was immediately carried out. Thus even though all keyboard input passes through the workstation, the subjective impression conveyed to the user was precisely the same as when a conventional typewriter was being used. When this software is not in operation, the workstation, keyboard and printer continue to be usable in the conventional computer driven manner.

The above concept simply created the illusion of a typewriter at a workstation without actually being capable of independent functioning absent the computer.

Alternatively in U.S. Pat. No. 4,859,092 a portable typewriter which includes a keyboard and a printer is disclosed. In this device a display monitor can be pivoted to reveal the keyboard and then further raised to reveal the printer. This device is a first generation type laptop computer with a flat panel display and a printer. The device enables the laptop user to display the text on the monitor and to make a printed copy without requiring a separate printer. While certainly a clever version of a laptop computer it was a very bulky and expensive combination to achieve the simple benefit of a printed copy.

### SUMMARY OF THE INVENTION

The present invention discloses a relatively inexpensive device that can internally include on or more of the functions of a printer, copier, scanner or fax machine in combination with a built-in typewriter device. Preferably the device is an all-in-one type device. That includes the features normally connected to a computer, but with an independently built-in operable typewriter function.

An all-in-one combinational device has a built-in typewriter and one or more internal printer, fax, copier, scanner device. The device has a housing structure for storing the built-in typewriter and each of the one or more one of the internal printer, fax, copier or scanner devices. The housing structure has a drop down portion containing a concealed typewriter keyboard. The keyboard is concealed when the drop down portion is stowed upright in the housing structure. When the drop down portion is opened, the typewriter can be activated and by inserting or loading a form or paper into a paper receiving device the paper or form can be typed on using the keyboard, printing on a keystroke by keystroke basis. Preferably the device includes an impact printer head to print on multi sheet forms. Alternatively the printer may use an office ink jet or laser cartridge printing device in combination with a print function software to allow for keystroke by keystroke input form the typewriter. In a preferred embodiment, the device also has a flip open top cover exposing a flat copy scanner glass for transmitting photo scanning copy images to the internal printing device for making a copy or to a connected external computer for storing scanned images.

### BRIEF DESCRIPTION OF THE DRAWINGS

FIG. 1 is a perspective view of the all-in-one combinational device according to the present invention.

FIG. 2 is a perspective view of the all-in-one combinational device of FIG. 1 with the drop down portion of the housing structure open exposing the typewriter keyboard.

FIG. 3 is an enlarged perspective view taken from FIG. 2 showing the typewriter keyboard and form/paper receiving portion.

FIG. 4 is a perspective view of the all-in-one combinational device with the top open showing the copy/scanner portion.

### DETAILED DESCRIPTION OF THE INVENTION

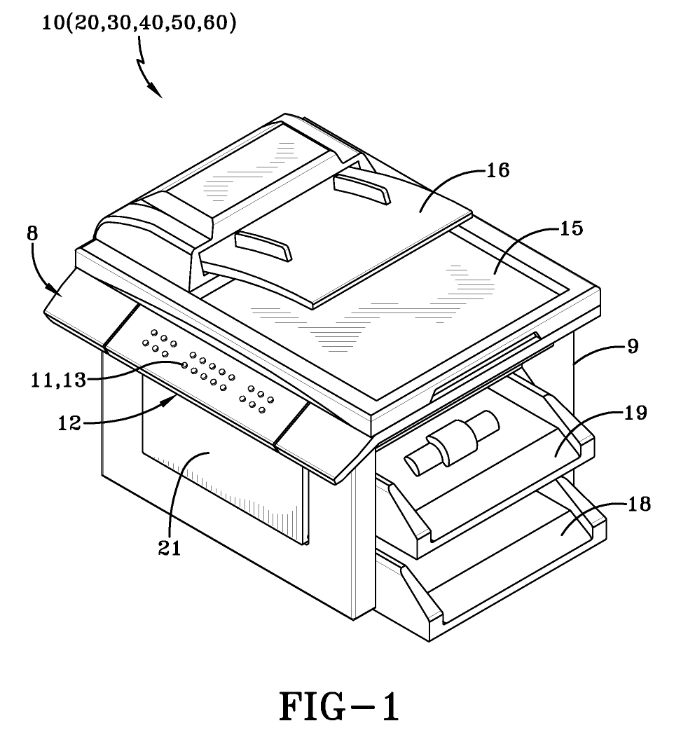

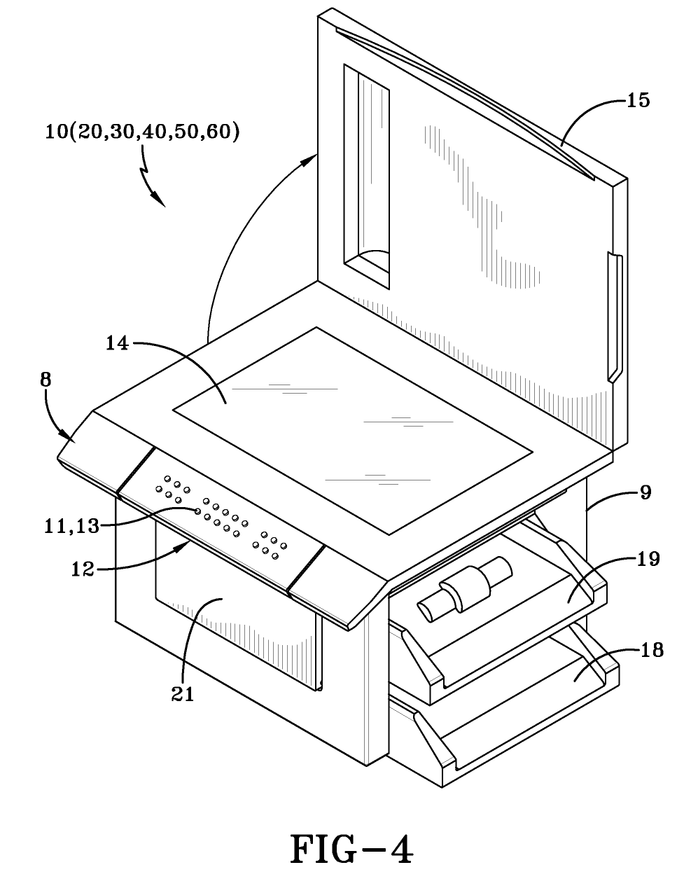

As shown in FIG. 1 is a perspective view of an all-in-one combinational device 10 as illustrated. The device 10 has a built-in typewriter 20 and one or more internal devices, features or capabilities including a printer 30, facsimile machine 40, a copier 50 or scanner device 60. As illustrated, the device 10 as shown has a tilt up front panel 12 including a multitude of buttons 11 or switches 13 that enables a proper function to be activated. As shown in FIG. 1 or 4, the device 10 can print a paper, a form or any of the documents collectively all referred to as 2, by loading it either onto a glass plate 14 under the top cover 15 or by feeding it into a feeder mechanism 16 which will then transmit a page by page copy to the glass plate 14 wherein a copy or scan or fax can be accomplished. As shown in the lower portion on one end is a paper supply tray 18 wherein the paper 2 can be loaded into the device 10 above the supply tray 18 is a document off load tray 19 for holding printed pages 2. The housing structure 8 as shown encloses all the necessary electronic and mechanical devices necessary for each of the components to properly operate or function. The device 10 has on the rear panel 9 connecting ports to allow telephone communications to be connected, a power cable to be plugged into a 110 outlet and an ethernet connection or other USB port to be connected directly to a computer (not shown) such that the machine can be operated either remotely from a computer or can be operated at the work station depending on the function required. The device 10 as shown with the exception of the built-in typewriter 20 is commonly sold by a variety of manufacturers. Conventional all-in-one type devices such as the HP3390 has all of the features shown above with the exception of a built-in typewriter 20. These features are commercially available and widely sold throughout the globe and their ease of use and simplicity of performance are well appreciated. Generally a software disk is provided with each combinational device such that all of the features can be connected electronically to a computer so that the all-in-one device can perform any of the necessary functions. This is also preferably done in the device 10.

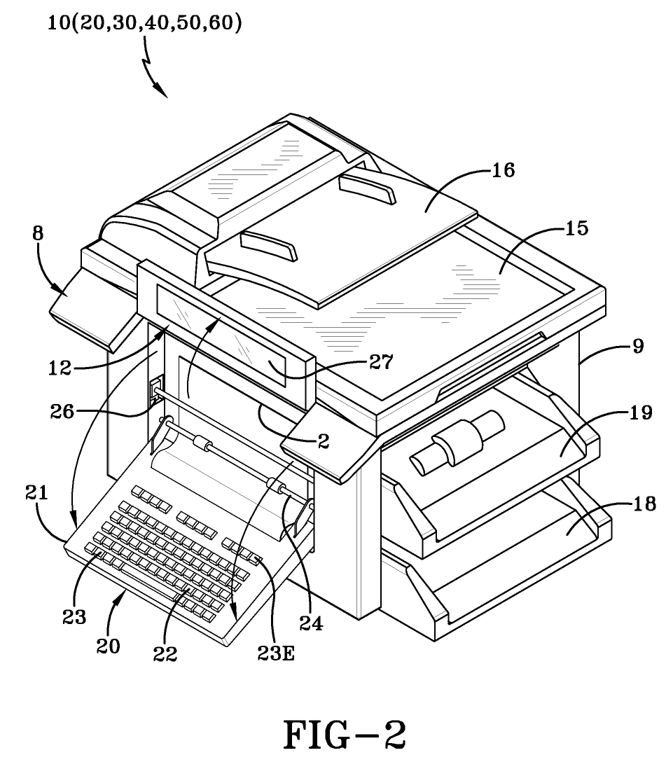

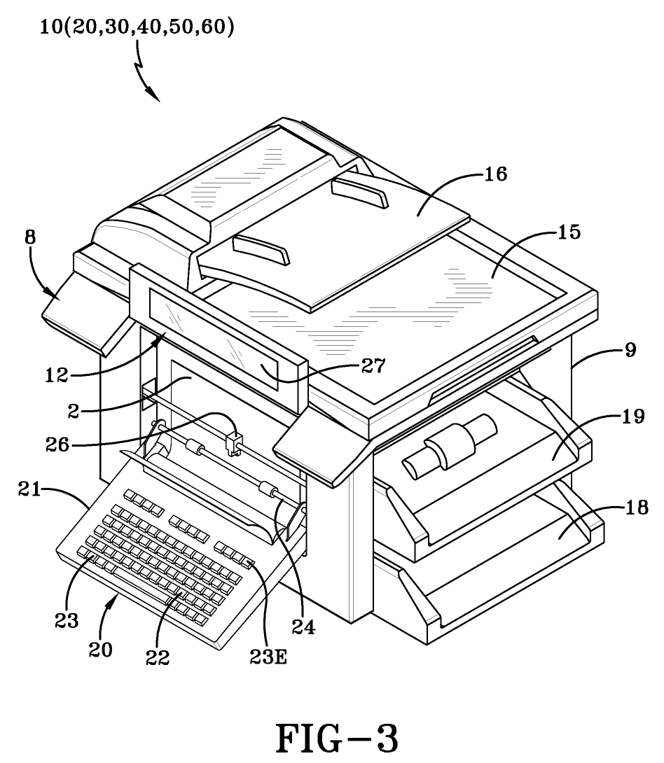

With reference to FIG. 2, enclosed within the combinatorial device 10 is a pulled out typewriter keyboard 22 attached or integral to a drop down portion 21 which is opened by moving the tilt up panel 12 upwardly and pulling the drop down portion 21 to the open position. The concealed keyboard 22 is thus unlatched and allowed to physically rotate into a position to expose the keyboard 22. The operator, by pressing any key 23, can then initiate typing on any printed form or document 2 that he or she so desires. In this fashion, the typewriter 20 can be isolated from the computer and the typing can be directly accomplished onto the form or printed document 2 required to be typed on. As shown in FIG. 3 the paper document 2 is fed into a typewriter receiver mechanism 24 wherein a printer head 26 can traverse across the paper 2 in a keystroke by keystroke basis, which provides the necessary input as the typist hits each key a letter impression is made directly onto the form 2. When the electronic keyboard 22 of the typewriter 20 is folded into the typewriter operating mode position as shown in FIG. 2, the device 10 transfers into the typewriter mode such that the keys 23 and typing functions of the software or electronics are automatically initiated so that the all-in-one combinational device 10 recognizes that a document 2 is going to be typed on. In such a case, the software is provided such that as user strikes a key 23 an impression can be made directly on a document 2. Similarly if so provided the typewriter device 20 can provide a white-out function directly through the printer head 26 such that an erase button can be pushed and the unit will backspace and remove the letter being applied. This works when you're not using multi-page documents or forms otherwise the impacting impression will be transferred through smudging the underlying layers, however, on a single piece form 2 it can be desirable to have an erase mode which was standard in some earlier typewriters and can be provided in this device 10 if so desired. Alternatively an image display screen 27 can be provided such that an entire word or phrase can be typed and then the entire work can be transmitted by hitting an enter key 23E and transmitted to the document or form 2 being printed. While this is not the preferred method of providing the necessary data input, it does provide a means for spell check prior to impacting the form. This type of device 10 is particularly useful in medical environments where pre-printed forms and cards are needed for patients and provides additional levels of security such that the documents can be put on hard copy, physical forms 2 and not transmitted over a large computer network system such as is provided when one stores such data on a system that may be accessible by more than one person.

The governmental entities such as the IRS and military also use a wide variety of forms 2. It is important in many cases that the information be provided on an authorized form 2, as such the device 10 becomes particularly useful. This device 10 eliminates the need for a separate typewriter, while providing all the necessary functions of a typewriter. As shown the device 10 is using an impact type printer head 26, and it may employ a cartridge or ribbon 28 to provide the necessary lettering onto the document 2. Alternatively an ink jet or laser type printer could be used in combination with the typewriter function. In such a case the internal printer device 30 currently provided for both the print 30 and copy 50 functions can be similarly adapted to provide the necessary typing function if so desired. This eliminates the need of additional components and yet still provides the useful keystroke by keystroke operation of the combinational device 10 of the present invention.

As shown in FIG. 3, the keyboard 22 provides large keys 23 similar to that of a keyboard of a computer and/or typewriter and similarly provides easy access to changing a printer head 26 or an ink jet or cartridge ribbon device (not shown) can be removed easily. Preferably the printer head 26 is operating as such that it traverses from a stowed position in the housing structure 8 when the typewriter keyboard 22 is in the folded up position and traverses to a print ready position in front of a document that has been inserted between the rollers as shown in FIG. 3 when the drop down portion 21 is opened.

With reference to FIG. 4, the device 10 is shown in an exemplary embodiment of the present invention that has a flip up top cover 15 that can be folded up such that a glass plate 14 is exposed. In such a case scanning or copying of books, manuals or other documents can easily be accomplished by simply lifting the top cover 15 and exposing the glass plate 14 and thereby pressing the necessary copy or scan function button 23 on the all-in-one combinational device as shown in FIG. 4. When closed, the device 10 looks virtually identical to any of the currently all-in-one combinational devices. Only when the typewriter function 20 is open so that the typewriter keyboard can be exposed. The user will notice this device 10 is uniquely different than any other all-in-one type combinational devices. The reason the current device 10 is so desirable, is that it includes both software capabilities already provided within an all-in-one combinational device but it also can help direct the keyboard functions of the built-in typewriter device 20, and furthermore, it eliminates unnecessary office desk space required to hold a separate typewriter. The device 10 as shown greatly facilitates the printing of envelopes if so desired while many printers provide for this function, sometimes it's easier to print directly on an envelope. This is easily afforded by the use of the typewriter function. Similarly labels and any other forms of oddly shaped documents 2 can be more easily configured directly if needed by using the built-in typewriter device 20 of the present invention. It is much simpler to direct and orient and properly position a typewriter function directly such that the impacted area is well within the space that is provided on the form 2. When one uses a printer 30 in an attempt to accomplish this on the form, it often causes misalignment of the paper and causes the operator to get the necessary information positioned so it is not entirely in the space provided. When this occurs, machine readable documents become totally useless if the document has not been properly positioned. With the present device 10, the operator can easily see the location of the form and can position the printer head 26 directly into the area where it needs to be typed and thereby when typing the operator can see and will know exactly that the form is printing exactly within the space provided. This has a tremendous advantage and is particularly useful such that any operator can easily operate this device 10 without any special training or skills.

While the device 10 as shown has a flat top with copy 50 and scan 60 ability with a lid or flip up cover 15 that opens exposing these features, alternatively, the device 10 can be provided in a unit that provides any one or more of these functions as such it can be provided with a smaller device that doesn't have a top feed, but has a normal feed such as commonly available with smaller printers. In such a case the built-in typing device 20 will be provided on the front panel and will again be a flip out device such that the operator can type directly onto the form as needed. This can be accomplished with a combinational typewriter mechanism wherein the additional features such as copying and faxing may or may not be included. These and other alternatives are possible within the scope of the present invention. The critical features are that the built-in typewriter device 20 is integral to the all-in-one combinational device 10 that has at least one or more of these other functions provided.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

1. An all-in-one combinational device comprising:
a built-in typewriter;
one or more internal printer, fax, copier or scanner devices.

2. The all-in-one combinational device of claim 1 comprises:
a housing structure for storing the built-in typewriter and each of the one or more of the internal printer, fax, copier or scanner devices.

3. The all-in-one combinational device of claim 1 wherein the housing has a drop down portion containing a typewriter keyboard, the keyboard being concealed when the drop down portion is stowed up in the housing structure.

4. The all-in-one combinational device of claim 1 wherein when the drop down portion is opened, the typewriter can be activated by inserting or loading a form or paper into a paper receiving device, and typing using the keyboard wherein a printer device prints on a keystroke by keystroke basis.

5. The all-in-one combinational device of claim 1 wherein the printer device includes an impact printer cartridge or ribbon.

6. The all-in-one combinational device of claim 1 wherein the printer device is an ink jet or laser printer with a print function software adapted to print on a keystroke by keystroke input from the typewriter function.

7. The all-in-one combinational device of claim 1 further comprises a flip top cover exposing a flat copy scanner glass plate for transmitting photo scanning or copy images to the internal printer device for making a copy or to a connected external computer for storing the scanned images.
